(19) United States
(12) Patent Application Publication
(10) Pub. No.: US 2016/0295645 A1
(43) Pub. Date: Oct. 6, 2016

(54) A WIRE TRAY FOR A MICROWAVE OVEN OR A COOKING APPLIANCE WITH MICROWAVE HEATING FUNCTION

(71) Applicant: ELECTROLUX APPLIANCES AKTIEBOLAG, Stockholm (SE)

(72) Inventor: Claudio MAZZON, Rothenburg ob der Tauber (DE)

(21) Appl. No.: 15/034,889

(22) PCT Filed: Jan. 13, 2015
(86) PCT No.: PCT/EP2015/050448

§ 371 Date: May 6, 2016

(30) Foreign Application Priority Data
Jan. 14, 2014 (EP) 14151142.8

(51) Int. Cl. H05B 6/64; F24C 15/16

(52) U.S. Cl. CPC H05B 6/6408; F24C 15/16

(57) ABSTRACT

The present invention relates to a wire tray (10) for a microwave oven or a cooking appliance with microwave heating function. Said wire tray (10) includes a plurality of rods (12) and a frame (14), wherein the rods (12) are arranged within the frame (14). At least parts or portions of the wire tray (10) are made of at least one microwave absorbing material and/or comprise at least one microwave absorbing material, so that the microwave absorbing material is heated up by the microwaves. Further, the present invention relates to a method for manufacturing a wire tray for a microwave oven or a cooking appliance with microwave heating function.

The present invention relates to a wire tray for a microwave oven or a cooking appliance with microwave heating function according to the preamble of claim 1. Further, the present invention relates to a method for manufacturing a wire tray for a microwave oven or a cooking appliance with microwave heating function.

Wire trays are commonly used in cooking ovens with standard heating function and microwave heating function. The wire trays are usually made of metal wires or metal rods welded together. However, this kind of construction is not suitable for microwave environment. Since metal wires, if not properly grounded, could generate arcing between the wire tray and support devices, e.g. side grids, the efficiency of the microwave heating is reduced. Further, the metal wires or metal rods of the wire tray avoid usually that the microwave passes through said wire tray, since the distances between the metal wires or metal rods are small compared to the wavelength of the microwave. The small distances between the metal wires or metal rods of the wire tray effect a modification of the microwave distribution inside the cavity. Thus, the wire tray acts as a reflector and/or deflector for the microwaves, and cavity mismatching occurs resulting in a loss of microwave power delivered to the food and/or in a poor evenness of heating. One of the current solutions to avoid arcing or sparking between the metal wired tray and the support device is to put a dielectric medium to the points of contact between grids and wire tray, in order to keep a minimum distance between them and avoid the sliding contact that may cause arcing. Currently on the market there are further accessories for microwave ovens like pizza trays or grill trays made out of variety of materials, mainly dielectric or ceramic with some ferrite or other metallic powder mixed together.

It is an object of the present invention to provide a wire tray for a microwave oven or a cooking appliance with microwave heating function, wherein said wire tray extends the functionality of the microwave appliance.

According to the present invention at least parts or portions of the wire tray are made of at least one microwave absorbing material and/or comprise at least one microwave absorbing material, so that the microwave absorbing material is heated up by the microwaves.

The main idea of the present invention is the use of the wire tray as an active element of the microwave oven. The wire tray contributes the heating to the food stuff. In contrast, a conventional wire tray is provided only for supporting the food stuff in the oven. The wire tray made of the microwave absorbing material absorbs microwaves and is heated up. Furthermore, the microwaves can propagate from the bottom side of the food stuff, since the microwave absorbing material absorbs only a certain percentage of the microwaves. In contrast, a conventional wire tray made of steel acts as a reflector and/or deflector for the electromagnetic microwave field. The microwave absorbing wire tray allows a faster cooking of the food.

In particular, the microwave absorbing material includes silicon carbide. Silicon carbide absorbs microwaves and is heated up in the microwave field.

The wire tray includes a plurality of rods and a frame, wherein the rods are arranged within the frame. According to a preferred embodiment of the invention, all of the plurality of rods can be made of at least one of said microwave absorbing material. Further, also said frame can be made of the microwave absorbing material.

For example, the wire tray is completely made of the microwave absorbing material. This wire tray has an homogeneous structure and is producible in an easy way.

In this case, the wire tray may be subdivided into zones including a group of neighboured rods, wherein the rods of different zones are made of different material compositions, so that different temperatures can be achieved on the wire tray. Different kinds of food stuff may be prepared within the same oven cavity at the same time.

According to another example, the wire tray comprises metal rolls, wherein at least a part of the rods is coated by elongated bushings made of the microwave absorbing material. It is also possible, that all rods are coated by elongated bushings made of the microwave absorbing material.

Preferably, the bushing is formed as a pipe section or a hollow cylinder.

Further, the bushing may include a gap extending in parallel to the longitudinal axis of said bushing. The bushing is pushable over the rod perpendicular to their common longitudinal axis.

In particular, the width of the gap is marginally smaller than the diameter of the corresponding rod, so that the bushing is pushable over the rod against a mechanical resistance.

Moreover, the wire tray may be subdivided into zones including a group of neighboured rods, wherein the bushings of different zones are made of different material compositions, so that different temperatures can be achieved on the wire tray. Also in this case, different kinds of food stuff may be prepared within the same oven cavity at the same time.

According to another embodiment, the wire tray comprises at least one grid element made of the microwave absorbing material. For example, the grid element may be circular and includes a number of rings and straight bars made of the microwave absorbing material.

Preferably, at least one of the straight bars is formed as a pipe section or a hollow cylinder and includes a gap extending in parallel to the longitudinal axis of said straight bar, wherein the width of the gap is marginally smaller than the diameter of the corresponding rod, so that the straight bar is pushable over the rod against a mechanical resistance.

In particular, the temperature of the part including a microwave absorbing material in particular silicon carbide, e.g. the wire of the tray, is determined by the percentage of the microwave absorbing material used to make said part. Thus, the temperatures on the wire tray are determinable. Adjusting the compositions of the microwave absorbing materials of the wire tray different temperatures may be obtained within the same wire tray. For example, a zone with a higher temperature is provided for meat, while a zone with a lower temperature is provided for grilling vegetables.

Further, the present invention relates to a method for manufacturing a wire tray for a microwave oven or a cooking appliance with microwave heating function, wherein the method comprises the steps of:
providing a mould formed complementary to the shape of the wire tray,
putting a powder of silicon carbide or of a mixture including silicon carbide another into the mould,
heating up the mould and the powder to a temperature between 1600° C. and 2500° C. in a furnace.

In particular, the method is provided for manufacturing the wire tray mentioned above.

The present invention will be explained in more detail below by means of exemplary embodiments. Thereby reference is made to the drawings, wherein

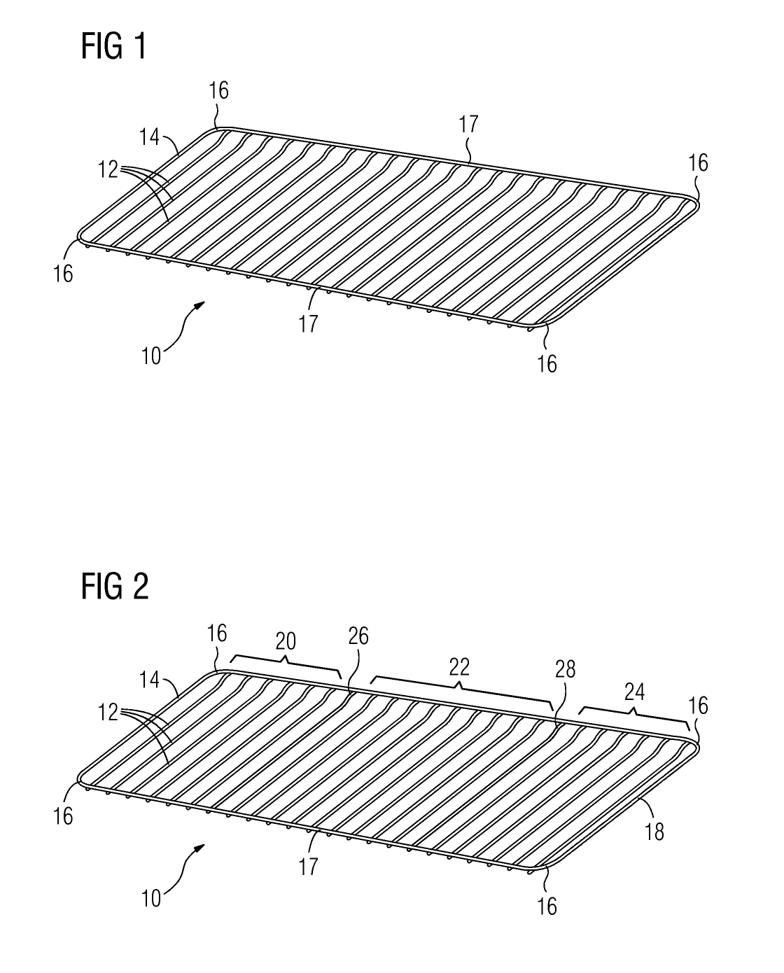

FIG. 1 illustrates a schematic perspective view of a wire tray for a microwave oven according to a first embodiment of the present invention,

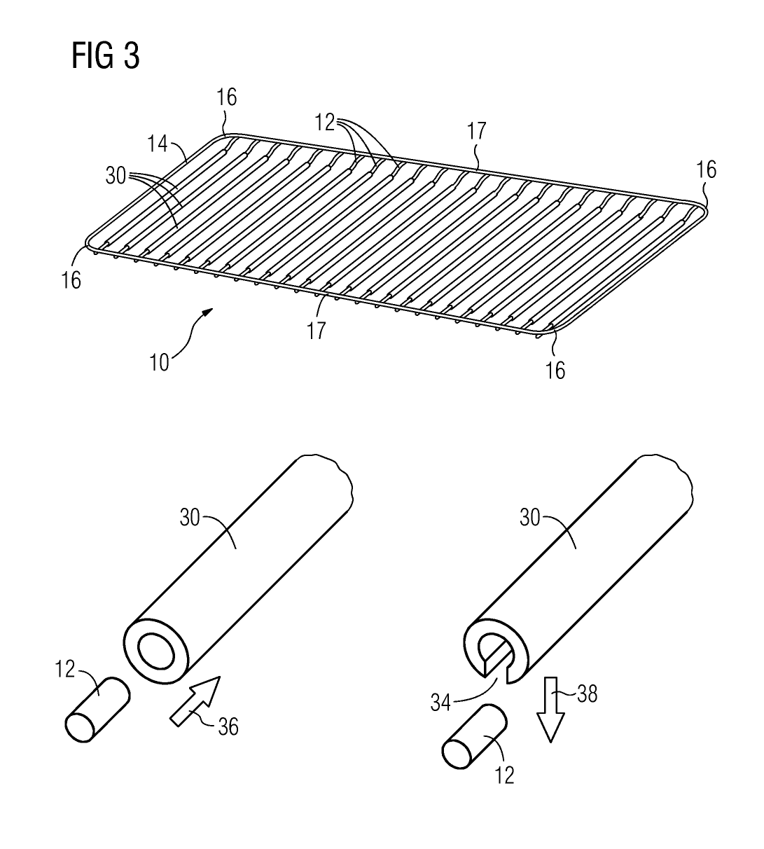

FIG. 2 illustrates a schematic perspective view of the wire tray for the microwave oven according to a second embodiment of the present invention,

FIG. 3 illustrates a schematic perspective view of the wire tray for the microwave oven according to a third embodiment of the present invention,

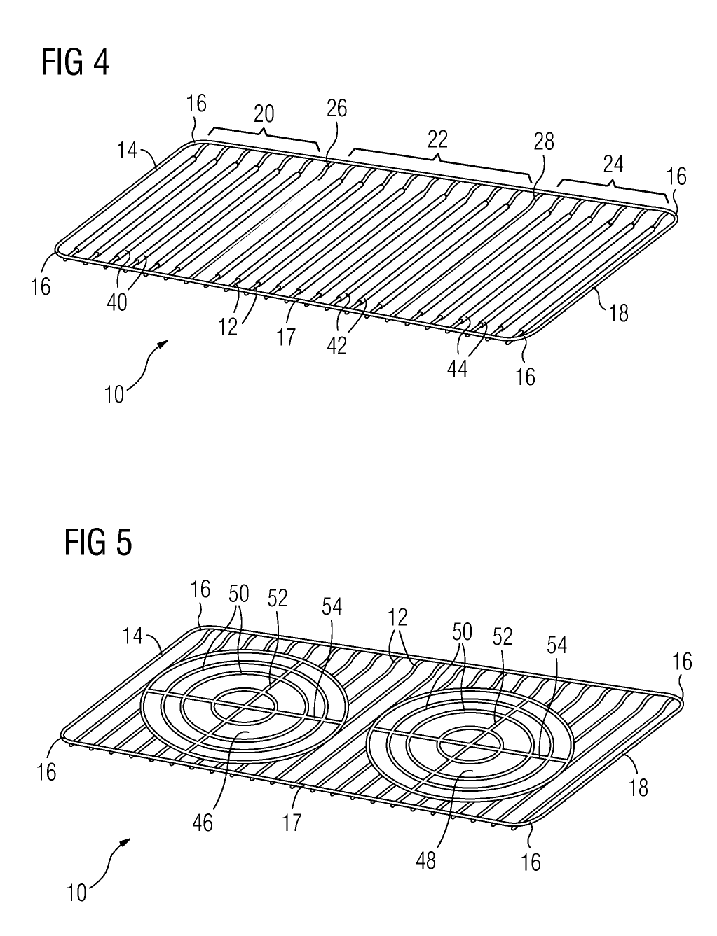

FIG. 4 illustrates a schematic perspective view of the wire tray for the microwave oven according to a fourth embodiment of the present invention, and

FIG. 5 illustrates a schematic perspective view of the wire tray for the microwave oven according to a fifth embodiment of the present invention.

FIG. 1 illustrates a schematic perspective view of a wire tray 10 for a microwave oven according to a first embodiment of the present invention.

The wire tray 10 includes a plurality of rods 12 and a frame 14. The rods 12 are arranged in parallel and side-by side. The frame 14 encloses the plurality of rods 12. The frame 14 has substantially a rectangular shape. Curvatures 16 are formed at the corners of the frame 14. The ends of the rods 12 are connected to longitudinal sides 17 of the frame 14. Each rod 12 has substantially a straight form. In this example, the long central portion of each rod 12 has the straight form, while both end portions of each rod 12 have an S-shaped or Z-shaped form. Alternatively, the whole rod 12 may have a straight form.

In this example, the wire tray 10 has a length of about 45 cm and a width of about 38 cm. Preferably, the cross section of the rods 10 has a diameter between 5 mm and 8 mm. For example, the cross section of the rods 10 is circular, ellipsoidal or polygon.

The wire tray 10 according to the first embodiment is completely made of microwave absorbing material. In this example, said wire tray 10 is completely made of a mixture including silicon carbide (SiC). The wire tray 10 made of the mixture including silicon carbide can be fabricated by putting a powder into a mould, wherein said mould has the shape of the wire tray 10. Then, the powder is treated in a high temperature furnace. Silicon carbide absorbs microwaves and is heated up in the microwave field.

Silicon carbide is a compound of silicon and carbon. In this example the percentage of carbon is about 70%. In this case, the wire tray 10 inserted in a normal domestic microwave oven with a power between 700 W and 1000 W will reach temperatures about 150° C. to 200° C. after one or two minutes. If the power level is set at the half of the maximum, then the double of said time is required in order to reach the same temperatures.

The wire tray 10 made of the mixture including silicon carbide absorbs microwaves. The microwaves can also propagate from the bottom side of the food stuff, since the mixture including silicon carbide absorbs only a certain percentage of the microwaves. In contrast, a conventional wire tray 10 made of steel acts as a reflector and/or deflector for the electromagnetic microwave field. The microwave absorbing wire tray 10 allows a faster cooking of the food.

The oven cavity and the microwave feeding system of the microwave oven can be designed to be well-matched with and without the wire tray 10 of the present invention. The microwave wave distribution inside the oven cavity can remain the same with and without the wire tray 10 of the present invention. Further, the microwave wave distribution in the oven cavity can be optimized, so that the same efficiency and working conditions of the microwave oven occurs independent of the microwave absorbing wire tray 10. In contrast, the metallic wire trays change the impedance of the oven cavity considerably due to the fact that steel wires acts as reflecting and/or deflecting medium. Thus, the efficiency and working conditions of the microwave oven depend on the structure of the metallic wire trays, while the efficiency and working conditions of the microwave oven are independent of the structure of the wire tray 10 according to the present invention.

FIG. 2 illustrates a schematic perspective view of the wire tray 10 for the microwave oven according to a second embodiment of the present invention.

The wire tray 10 of the second embodiment includes the plurality of rods 12 and the frame 14. The rods 12 are arranged in parallel and side-by side. The frame 14 encloses the plurality of rods 12 and has substantially the rectangular shape. Curvatures 16 are formed at the corners of the frame 14. The ends of the rods 12 are connected to the longitudinal sides of the frame 14. The wire tray 10 of the second embodiment has substantially the same size as the wire tray 10 of the first embodiment. The wire tray 10 of the second embodiment has substantially the same structure and geometric properties as the first embodiment.

The wire tray 10 according to the second embodiment is also completely made of a microwave absorbing material, in particular a mixture including silicon carbide. However, the wire tray 10 includes four zones 18, 20, 22 and 24 with different material compositions.

A first zone 18 includes the frame 14 and two rods 26 and 28. A second zone 20 includes a group of neighboured rods 12 in a lateral portion of the wire tray 10. In this example, the second zone 20 includes six neighboured rods 12. A third zone 22 includes a group of neighboured rods 12 in a central portion of the wire tray 10. In this example, the third zone 22 includes nine neighboured rods 12. A fourth zone 24 includes a group of neighboured rods 12 in another lateral portion of the wire tray 10. In this example, the fourth zone 24 includes six neighboured rods 12. The rod 26 of the first zone 18 is arranged between the second zone 20 and the third zone 22. In a similar way, the rod 28 of the first zone 18 is arranged between the third zone 22 and the fourth zone 24.

In the first zone 18 the mixture including silicon carbide comprises a percentage of carbon less than 15% in order to minimize the heating of the frame 14. In the second zone 20 the mixture including silicon carbide comprises a percentage between 65% and 70% carbon and 25% molasses. In the third zone 22 the mixture including silicon carbide comprises a percentage between 45% and 50% carbon and 40% molasses. In the fourth zone 24 the silicon carbide comprises a percentage between 25% and 30% carbon and 60% molasses. The second zone 20 is provided for the highest temperatures, the third zone 22 for intermediate temperatures, and the fourth zone 24 for relative low temperatures. The higher the percentage of carbon, the higher is the temperature obtained.

When the wire tray 10 of the second embodiment is put into a microwave oven of a power between 700 W and 1000 W and radiated for one or two minutes, then a temperature between 150° C. and 200° C. is obtained in the second zone 20. In this situation, a temperature between 100° C. and 150° C. is obtained in the third zone 22, while a temperature between 70° C. and 120° C. is obtained in the fourth zone 24. High temperatures are obtained by increasing the radiation time.

FIG. 3 illustrates a schematic perspective view of the wire tray 10 for the microwave oven according to a third embodiment of the present invention.

The wire tray 10 of the third embodiment includes the plurality of rods 12 and the frame 14. The rods 12 are arranged in parallel and side-by side. The frame 14 encloses the plurality of rods 12. The frame 14 has substantially the rectangular shape, wherein curvatures 16 are formed at the corners of said frame 14. The ends of the rods 12 are connected to the longitudinal sides 17 of the frame 14. The wire tray 10 of the third embodiment has substantially the same structure and geometric properties as the first and second embodiment.

The wire tray 10 according to the third embodiment is made of metal and a microwave absorbing material, in particular a mixture including silicon carbide. The rods 12 and the frame 14 are made of metal, wherein the straight central portion of each rod 12 is coated by an elongated bushing 30. Said bushing 30 is made of the mixture including silicon. The bushing 30 is formed as a pipe section or a hollow cylinder. The inner diameter of the bushing 30 is equal or marginally bigger than the outer diameter of the rod 12.

FIG. 3 shows an enhanced schematic partial perspective view of the bushing 30 and the rod 12. Moreover, FIG. 3 shows another enhanced schematic partial perspective view of a further bushing 32 and the rod 12. The further bushing 32 includes an elongated gap 34 extending in parallel to the longitudinal axis of said further bushing 32. The bushing 30 is pushed over the rod 12 along their common longitudinal axis according to a first arrow 36, before the corresponding rod 12 is connected to the frame 14. In contrast, the further bushing 32 is pushed over the rod 12 perpendicular to their common longitudinal axis according to a second arrow 38, after the corresponding rod 12 is connected to the frame 14. Of course, the further bushing 32 may be also pushed over the rod 12 perpendicular to their common longitudinal axis according to the second arrow 38, before the corresponding rod 12 is connected to the frame 14. Moreover, the further bushing 32 may be pushed over the rod 12 along their common longitudinal axis according to the first arrow 36. The gap 34 offers two different options for assembling the rod 12, the frame 14 and the further bushing 32. Preferably, the width of the gap 34 of the further bushing 32 is marginally smaller than the diameter of the rod 12. Thus, the further bushing 32 is pushed over the rod 12 according to the second arrow 38 against a mechanical resistance.

FIG. 4 illustrates a schematic perspective view of the wire tray 10 for the microwave oven according to a fourth embodiment of the present invention.

The wire tray 10 of the fourth embodiment includes the plurality of rods 12 and the frame 14. The wire tray 10 of the fourth embodiment has substantially the same structure and geometric properties as the other three embodiments.

The wire tray 10 according to the fourth embodiment is made of metal and a microwave absorbing material, in particular a mixture including silicon carbide as in the third embodiment. The rods 12 and the frame 14 are made of metal, wherein the straight central portions of the rod 12 are coated by elongated bushings 40, 42 and 44. Said bushings 40, 42 and 44 are made of silicon carbide. The bushings 40, 42 and 44 are formed as pipe sections or hollow cylinders. The inner diameters of the bushings 40, 42 and 44 are equal or marginally bigger than the outer diameters of the rods 12.

Similar to second embodiment, the wire tray 10 according to the fourth embodiment includes four zones 18, 20, 22 and 24. The bushings 40, 42 and 44 in the zones 20, 22 and 24 have different material compositions. A first zone 18 includes the frame 14 and the two rods 26 and 28. A second zone 20 includes a group of neighboured rods 12 with first bushings 40 in a lateral portion of the wire tray 10. In this example, the second zone 20 includes six neighboured rods 12 with first bushings 40. A third zone 22 includes a group of neighboured rods 12 with second bushings 42 in a central portion of the wire tray 10. In this example, the third zone 22 includes nine neighboured rods 12 with second bushings 42. A fourth zone 24 includes a group of neighboured rods 12 in another lateral portion of the wire tray 10. In this example, the fourth zone 24 includes six neighboured rods 12 with third bushings 44. The rod 26 of the first zone 18 is arranged between the second zone 20 and the third zone 22. In a similar way, the rod 28 of the first zone 18 is arranged between the third zone 22 and the fourth zone 24.

In the second zone 20 the mixture including silicon carbide of the first bushings 40 comprises a percentage between 65% and 70% carbon and 25% molasses. In the third zone 22 the mixture including silicon carbide of the second bushings 42 comprises a percentage between 45% and 50% carbon and 40% molasses. In the fourth zone 24 the mixture including silicon carbide of the third bushings 44 comprises a percentage between 25% and 30% carbon and 60% molasses. The second zone 20 is provided for the highest temperatures, the third zone 22 for intermediate temperatures, and the fourth zone 24 for relative low temperatures. The higher the percentage of carbon, the higher is the temperature obtained.

FIG. 5 illustrates a schematic perspective view of the wire tray 10 for the microwave oven according to a fifth embodiment of the present invention.

The wire tray 10 of the fifth embodiment includes the plurality of rods 12 and the frame 14. The rods 12 are arranged in parallel and side-by side. The frame 14 encloses the plurality of rods 12. The frame 14 has substantially the rectangular shape, wherein curvatures 16 are formed at the corners said frame 14. The ends of the rods 12 are connected to the longitudinal sides 17 of the frame 14. The wire tray 10 of the fifth embodiment has substantially the same structure and geometric properties as the other embodiment.

The wire tray 10 according to the fifth embodiment is made of metal and a microwave absorbing material, in particular a mixture including silicon carbide. The rods 12 and the frame 14 are made of metal. Two circular grid elements 46 and 48 are arranged upon the rods 12. The circular grid elements 46 and 48 are made of the mixture including silicon carbide. Each grid element 46 and 48 includes a number of concentric rings 50 and two straight bars 52 and 54, wherein said straight bars 52 and 54 are arranged as a cross. In this example, each grid element 46 includes four concentric rings 48.

For example, the circular grid elements 46 and 48 have different material compositions, so that different temperatures are obtained at the circular grid elements 46 and 48. The circular grid elements 46 and 48 may be fastened at the rods 12 by the straight bar 52 parallel to the rod 12. In this case, the straight bar 52 may be formed as the further bushing 32 in FIG. 3.

The wire tray 10 of the present invention may have the same structure and geometric properties as a conventional metallic wire tray. The wire tray 10 of the present invention or at least its rods 12 are made of microwave absorbing materials, e.g. a sintered mixture including silicon carbide. Silicon carbide is a compound of silicon and carbon. The simplest manufacturing process is to combine silica sand and carbon in a furnace at a high temperature, between 1600 and 2500° C., depending on the use of the final material.

For example, methods of producing silicon carbide are known from U.S. Pat. No. 2,431,326 and DE 1 088 863.

Silicon carbide powders can be produced by three principal methods. The first method is a pyrolysis of silane compounds. The second method is a direct carbonisation of metallic silicon. The third method is a thermal reduction of silicon oxide.

A mixture of pure silica sand and carbon in the form of finely ground coke is built up around a carbon conductor within a brick electrical resistance-type furnace. Electric current is passed through the conductor, bringing about a chemical reaction in which the carbon in the coke and silicon in the sand combine to form silicon carbide and carbon monoxide gas.

Powder of silicon carbide can be used to obtain very hard ceramics by sintering process. Said hard ceramics are widely used in applications requiring high endurance such as car brakes, car clutches and ceramic plates in bulletproof vests. Silicon carbide is also used to build melting pots for copper/gold melting in the recycling industry.

Use of silicon carbide is also known in the manufacturing of light emitting diodes (LED). Silicon carbide is classed as a semiconductor and has an electrical conductivity between those of metals and insulating materials. The electrical conductivity in combination with the thermal properties allows that silicon carbide is a possible substitute for traditional semiconductor materials, e.g. silicon, in high temperature applications.

Since the hardness of silicon carbide is between corundum and diamond, another important application of silicon carbide is in the abrasive industry. Silicon carbide has a low thermal expansion and a high thermal conductivity. Further silicon carbide can withstand several thermal shocks without damages or modifications.

Silicon carbide is a semiconductor and can be heated up very soon, if inserted in a strong electromagnetic field like in a microwave oven. The rate of the heating up depends on the purity of silicon carbide and the mixture including silicon carbide. As an example, a disc with a diameter of 100 mm and a thickness of 5 mm made of silicon carbide with a purity of 95% to 98% and sintered at 2400° C. can easily reach temperatures above 1000° C. in a normal microwave oven with a power of 900 W to 1000 W within a few minutes only by microwave radiation and without any further conventional heating.

Silicon carbide can be also used in composition with other materials, for example in composition with magnesium oxide, aluminium oxide, aluminium nitride, beryllium oxide and/or magnesia oxide. In particular, silicon carbide can be used in microwave appliances as a susceptor material. Current other typical susceptor materials are ferrites, oxides, graphite and carbides. The advantages of silicon carbide compared to other materials are the low cost and the capability to withstand thermal shocks and high temperatures without modifications.

The wire tray 10 according to the present invention may be used in microwave ovens without creating arcing. The efficiency of the microwave oven is not affected by inserting the wire tray 10 into the oven. The energy delivered from the magnetron is kept by the absorbing wires and transferred to the food stuff.

A common microwave appliance can be used as a fast barbeque. In this case, the user runs the microwave oven with the wire tray 10 inside for some seconds at full power, so that the rods 12 are heated up. Then, the user put the food on the tray and runs the oven with conventional heating function and/or with microwave heating function at low power in order to complete the cooking process.

Adjusting the compositions of the microwave absorbing materials of the wire tray 10 different temperatures may be obtained within the same wire tray 10. For example, a zone with a higher temperature is provided for meat, while a zone with a lower temperature is provided for grilling vegetables. Thus, it is possible to cook different kind of food on the same wire tray 10 at the same time.

These zones may have different shapes, e.g. squared or circular. Further, more than two zones may be provided. Also cold zones may be formed on the wire tray 10, in which the material of the rods 12 does not absorb microwaves. The inventive wire tray 10 may be also used in standard oven with conventional heating systems. The wire tray 10 can be designed in such a way that a part of the microwave energy can pass through it and reach the food also from the bottom part. This is usually not possible by common metallic wire trays.

As stated above, a suitable powder for the microwave absorbing material may be silicon carbide, but also a mixture containing silicon carbide. For production reasons it may be necessary to add some other components to the silicon carbide in order to provide a mixture containing silicon carbide that supports the forming and/or production process of the wire tray or parts thereof. For example, the document U.S. Pat. No. 2,431,326 discloses an additive denoted as molasses and basically inserted in order to obtain a final compound more fluid or more suitable for extrusion.

Although illustrative embodiments of the present invention have been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 wire tray
12 rod
14 frame
16 curvature
17 longitudinal side
18 first zone
20 second zone
22 third zone
24 fourth zone
26 rod
28 rod
30 bushing
32 further bushing
34 gap
36 first arrow
38 second arrow
40 first bushing
42 second bushing
44 third bushing
46 circular grid element
48 circular grid element
50 ring
52 straight bar
54 straight bar

1. A wire tray for a microwave oven or a cooking appliance with microwave heating function, said wire tray comprising a plurality of rods and a frame, wherein the rods are arranged within the frame, and wherein at least parts or portions of the wire tray are made of at least one microwave absorbing material and/or comprise at least one microwave absorbing material, so that the microwave absorbing material is heated up by microwaves.

2. The wire tray according to claim 1, wherein the microwave absorbing material includes silicon carbide.

3. The wire tray according to claim 1, wherein all of said plurality of rods are made of at least one microwave absorbing material.

4. The wire tray according to claim 3, characterized in that the wire tray is subdivided into zones including a group of neighboured rods, wherein the rods of different zones are made of different material compositions, so that different temperatures are provided on the wire tray.

5. The wire tray according to claim 1, wherein the wire tray is made of metal, wherein at least a part of the rods is coated by elongated bushings made of the microwave absorbing material.

6. The wire tray according to claim 5, each said bushing being formed as a pipe section or a hollow cylinder.

7. The wire tray according to claim 5, wherein each said bushing includes a gap extending in parallel to the longitudinal axis of said bushing.

8. The wire tray according to claim 7, wherein the width of the gap is marginally smaller than the diameter of the corresponding rod, so that the bushing is pushable over the rod against a mechanical resistance.

9. The wire tray according to claim 5, wherein the wire tray is subdivided into zones including a group of neighboured rods, wherein the bushings of different zones are made of different material compositions, so that different temperatures are provided on the wire tray.

10. The wire tray according to claim 1, wherein the wire tray is made of metal and comprises at least one grid element made of the microwave absorbing material.

11. The wire tray according to claim 10, wherein the grid element is circular and includes a number of rings and straight bars made of the microwave absorbing material.

12. The wire tray according to claim 11, wherein at least one of the straight bars is formed as a pipe section or a hollow cylinder and includes a gap extending in parallel to the longitudinal axis of said straight bar, wherein the width of the gap is marginally smaller than the diameter of the corresponding rod, so that the straight bar is pushable over the rod against a mechanical resistance.

13. The wire tray according to claim 2, wherein the temperature of the microwave absorbing material including silicon carbide is determined by the percentage of carbon therein.

14. A method for manufacturing a wire tray for a microwave oven or a cooking appliance with microwave heating function, the method comprising the steps of:
providing a mould formed complementary to the shape of the wire tray,
putting a powder of silicon carbide or of a mixture including silicon carbide and/or of any other microwave absorbing material into the mould,
heating up the mould and the powder to a temperature between 1600° C. and 2500° C. in a furnace.

15. The method according to claim 14, further comprising producing the wire tray according to claim 1.

16. The wire tray according to claim 1, said wire tray being completely made of microwave absorbing material.

17. The wire tray according to claim 5, wherein all said rods are coated by elongated bushings made of the microwave absorbing material.
